(19) United States
(12) Patent Application Publication
(10) Pub. No.: US 2012/0156435 A1
(43) Pub. Date: Jun. 21, 2012

(54) Structure of composite board

(75) Inventors: Chun-Ting Yang, Taipei (TW); Pao-Ching Yang, Taipei (TW)

(73) Assignee: CAROL YOUNG CORPORATION, Taipei (TW)

(21) Appl. No.: 12/926,874

(22) Filed: Dec. 15, 2010

(51) Int. Cl. B32B 3/30

(52) U.S. Cl. 428/167

(57) ABSTRACT

A structure of composite board includes a board, a first covering layer, and a second covering layer. The board has an upper surface and a lower surface opposite to the upper surface, and the upper surface forms a plurality of grooves that is substantially parallel to each other. The first covering layer has an upper surface and a lower surface opposite to the upper surface, and the upper surface is bonded to the lower surface of the board. The second covering layer has an upper surface and a lower surface opposite to the upper surface, and the upper surface is bonded to the lower surface of the first covering layer. As such, the composite board, when attached to a column, ensures the advantageous characteristics of water resistance, sound isolation, thermal isolation, and beautiful appearance.

### FIELD OF THE INVENTION

The present invention relates to a structure of composite board, and in particular to a composite board, which when attached to a column, provides the advantages in respect of water resistance, sound isolation, thermal isolation, and beautiful appearance.

### BACKGROUND OF THE INVENTION

Proper decoration usually brings a new impression to a building and improves quality of dwelling. Wooden boards are commonly in house decoration and a variety of wooden boards are available in the market, including lumber, core plywood, particle board, medium density fiberboard (MDF board), high density fiberboard (HDF board), chemical board, and plywood, which are commonly use for house decoration (or furniture). Since they are different structures and thus provide different uses.

Referring to FIGS. 1 and 2 of the attached drawings, a conventional board 11 for house decoration is subjected to certain processing, such as a wooden veneer 12 is adhesive on an upper surface 11A of a board 11 and adhesively attaching a paper sheet 13 to a lower surface 11B of the board 11. The board may then be attached to a wall to provide advantages of for example water resistance, sound isolation, and thermal isolation. However, to be applicable to a column 3 (or a wall corner), the board 11 must be grooved for foldability before being attached to the curved surface. One of the currently used ways is to form a plurality of parallel grooves in the upper surface 11A of the board 11. However, since the upper surface 11A of the board 11 is originally bonded with a wooden veneer 12. After the grooving operation, the wooden veneer 12 is broken and thus losing the function of barrier. Further, the grooving operation forms a plurality of grooves 14 that is of a color different from that of the wooden veneer 12, making it awkwardly conspicuous and thus leading to unpleasant aesthetics.

Thus, the present invention aims to provide a board that ensures water resistance, sound isolation, thermal isolation, and beautiful appearance when being applied to a column or curved surface.

### SUMMARY OF THE INVENTION

An objective of the present invention is to provide a structure of composite board, wherein a board has an upper surface that forms a plurality of grooves that is substantially parallel to each other and a lower surface that is bonded to an upper surface of a first covering layer and the first covering layer has a lower surface that is bonded to an upper surface of a second covering layer, whereby when the board of the present invention, when attached to a column, effectively ensures the advantageous characteristics of water resistance, sound isolation, thermal isolation, and beautiful appearance.

To realize the above objective, the present invention provides a structure of composite board, which comprises a board, a first covering layer, and a second covering layer. The board has an upper surface and a lower surface opposite to the upper surface. The upper surface forms a plurality of grooves that is substantially parallel to each other. The first covering layer has an upper surface and a lower surface that is opposite to the upper surface, and the upper surface is bonded to the lower surface of the board. The second covering layer has an upper surface and a lower surface that is opposite to the upper surface, and the upper surface is bonded to the lower surface of the first covering layer. The board can be a medium density fiberboard (MDF), high density fiberboard (HDF), or chemical board; the first covering can be a sheet of paper, fabric, plastic film, or metal film; and the second covering layer can be a wooden veneer, metal film, or plastic decoration sheet. As such, when the composite board of the present invention is attached to a column, the advantageous characteristics water resistance, sound isolation, thermal isolation, and beautiful appearance can be ensured.

### BRIEF DESCRIPTION OF THE DRAWINGS

The present invention will be apparent to those skilled in the art by reading the following description of a preferred embodiment thereof with reference to the drawings, in which:

FIG. 1 is a schematic view showing the structure of a conventional composite board;

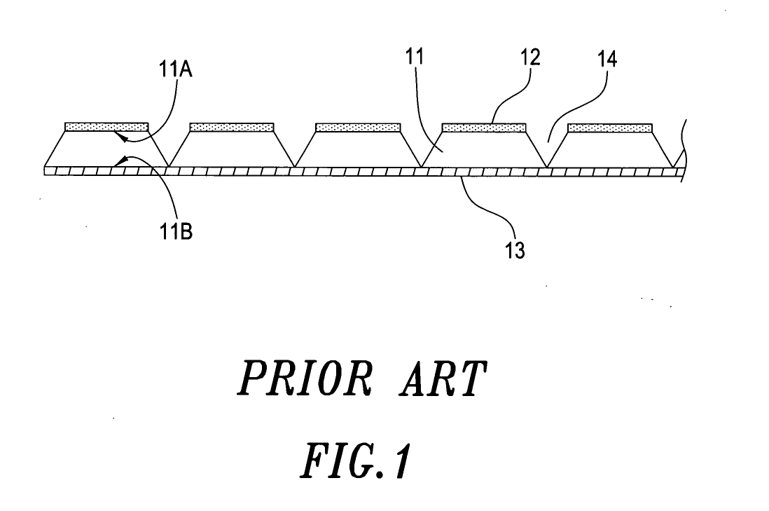

FIG. 2 is a schematic view demonstrating an application of the conventional composite board;

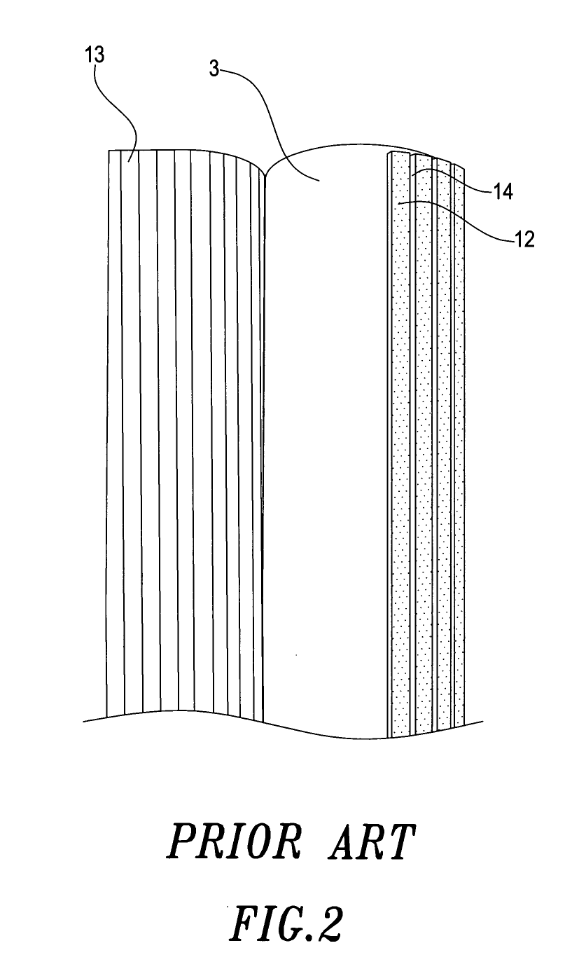

FIG. 3 is a schematic view showing a structure of composite board according to the present invention;

FIG. 3A is an exploded view showing the structure of composite board according to the present invention; and

FIG. 4 is a schematic view demonstrating an application of the composite board according to the present invention.

### DETAILED DESCRIPTION OF THE PREFERRED EMBODIMENT

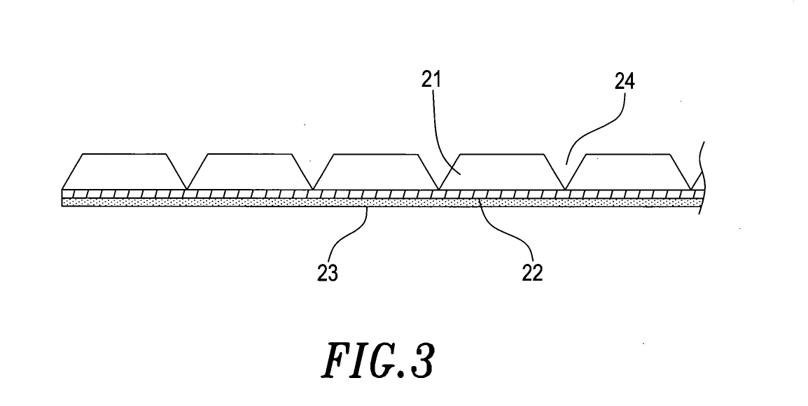

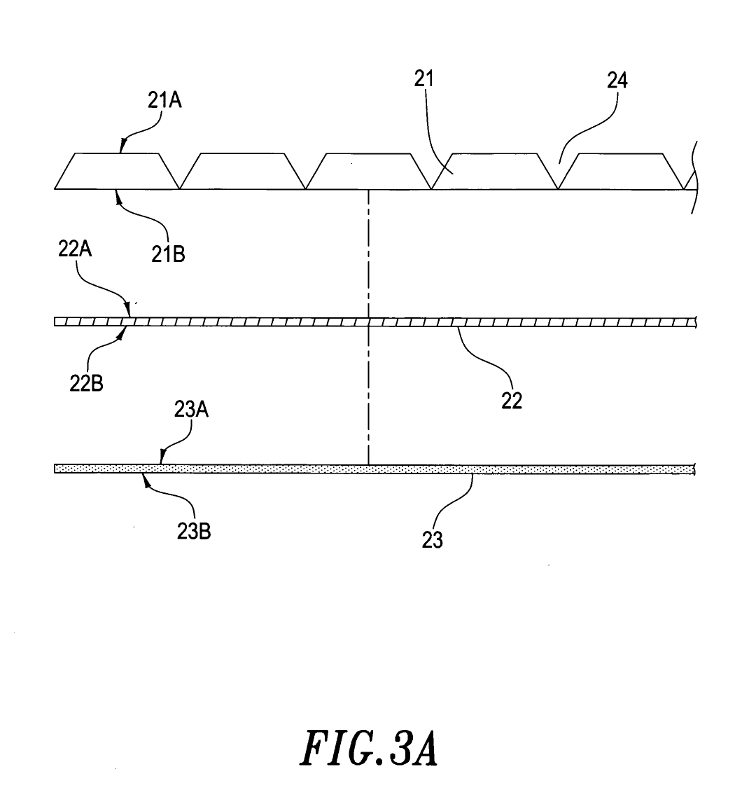

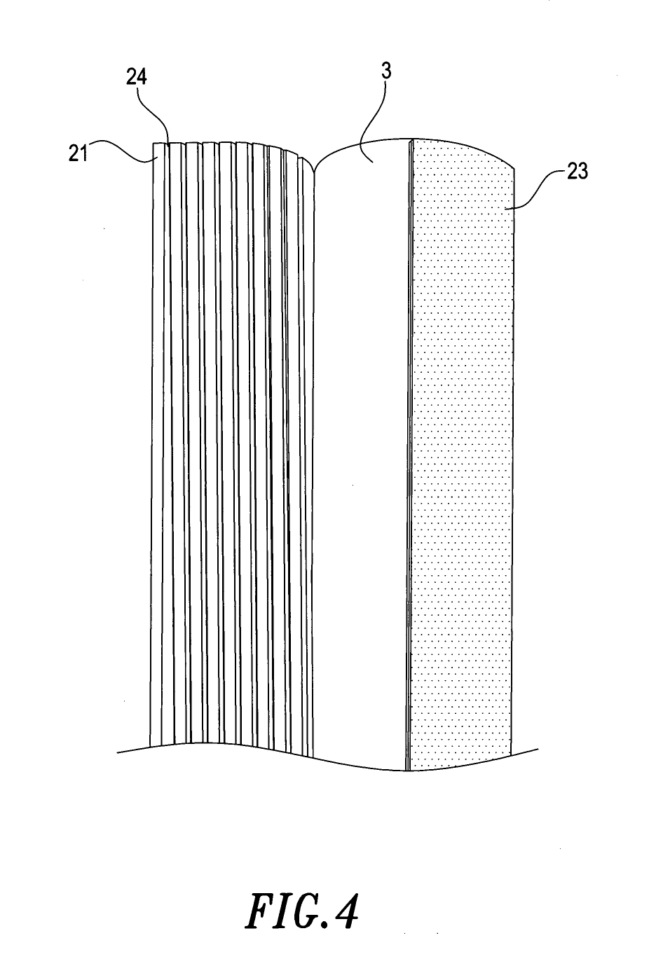

With reference to the drawings and in particular to FIGS. 3, 3A, and 4, which respectively show a schematic view and an exploded view of a structure of composite board according to the present invention and a schematic view demonstrating an application of the composite board of the present invention, the structure of composite board comprises a board 21, a first covering layer 22, and a second covering layer 23. The board 21 can be for example a medium density fiberboard (MDF), or a lumber, or any other engineering wood or boards of equivalent function. The board 21 comprises an upper surface 21A and a lower surface 21B opposite to the upper surface 21A, and the upper surface 21A forms a plurality of grooves 24 that is substantially parallel to each other. With the arrangement of the grooves 24, the board 21 is foldable or bendable. The first covering layer 22 may comprise a sheet material of any one of paper, fabric (such as nonwoven fabric), plastic film, and metal film (such as aluminum film). The first covering layer 22 has an upper surface 22A and a lower surface 22B opposite to the upper surface 22A, and the upper surface 22A is bonded to the lower surface 21B of the board 21. Since the first covering layer 22 is relatively flexible (or extendible) with respect to the board 21, the first covering layer 22, when bonded to the lower surface 21B of the board 21, helps preventing the board 21 from being broken due to folding or bending. Further, the first covering layer 22 also offers an advantageous characteristic of easy adhesive application. The second covering layer 23 may comprise for example a wooden veneer (or other natural or synthetic leather). The second covering layer 23 has an upper surface 23A and a lower surface 23B opposite to the upper surface 23A, and the upper surface 23A is bonded to the lower surface 22B of the first covering layer 22. Since the second covering layer 23 carries a more beautiful texture as compared to the lower surface 23B, the second covering layer provides an advantageous efficacy of beautiful appearance.

Preferably, in the manufacture of the structure of composite board according to the present invention, the material and size of the board 21 are first set and then cutting is performed on the board 21, followed by bonding to a first covering layer 22. Afterwards, grooving is performed in the upper surface 21A (with the number and depth of the grooves 24 being set in advance). Since the lower surface 21B of the board 21 is first bonded to the upper surface 22A of the first covering layer 22 before grooving, the board 21 is not easily broken by the grooving operation, and due to the flexibility (or extendibility) of the first covering layer 22, the board 21, when folded or bent, does not easily break. Finally, a second covering layer 23 is provided and bonded to the first covering layer 22 to complete the manufacture of the composite board according to the present invention.

In use, the upper surface 21A of the board 21 of composite board structure according to the present invention is first applied with adhesives and then attached to a column 3 (which can be an angled column, a cylindrical column, or a column of any desired shape and angle), so that an outer surface of the column 3 forms a continuous, integrated surface, which besides being of beautiful appearance, provides advantageous efficacies of water resistance, sound isolation, and thermal isolation. It is apparent that the second covering layer 23 can be of or carry any desired patterns or decorations for versatility and change of decorated environmental atmosphere.

In summary, the structure of composite board according to the present invention shows the following characteristics:

With the arrangement that a plurality of substantially-parallel grooves 24 is defined in the upper surface 21A of the board 21, the lower surface 21B of the board 21 is bonded to the upper surface 22A of the first covering layer 22, and the lower surface 22B of the first covering layer 22 is bonded to the upper surface 23A of the second covering layer 23, the board 21 is protected from direct contact with the surrounding environment, whereby when the composite board of the present invention is attached to a column 3, the advantageous efficacies of water resistance, sound isolation, thermal isolation, and beautiful appearance can be realized.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A structure of composite board, comprising:
a board, which has an upper surface and a lower surface opposite to the upper surface, the upper surface forming a plurality of grooves that is substantially parallel to each other;
a first covering layer, which has an upper surface and a lower surface opposite to the upper surface, the upper surface being bonded to the lower surface of the board; and
a second covering layer, which has an upper surface and a lower surface opposite to the upper surface, the upper surface being bonded to the lower surface of the first covering layer.

2. The structure of composite board as claimed in claim 1, wherein the board comprises one of a medium density fiberboard, high density fiberboard, and chemical board.

3. The structure of composite board as claimed in claim 1, wherein the first covering layer comprises one of a paper sheet, a fabric sheet, a plastic film, and a metal film.

4. The structure of composite board as claimed in claim 1, wherein the second covering layer comprises one of a wooden veneer, metal film, and plastic decoration sheet.
